(19) United States
(12) Patent Application Publication
(10) Pub. No.: US 2025/0266051 A1
(43) Pub. Date: Aug. 21, 2025

(54) ECHO REMOVAL AND SPEECH ENHANCEMENT

(71) Applicant: Google LLC, Mountain View, CA (US)

(72) Inventor: Rajeev Nongpiur, Mountain View, CA (US)

(21) Appl. No.: 18/443,028

(22) Filed: Feb. 15, 2024

(51) Int. Cl. G10L 21/0208

(52) U.S. Cl. CPC G10L 21/0208; G10L 2021/02082

(57) ABSTRACT

A method including receiving a microphone signal from a microphone, receiving a speaker signal from a speaker associated with the microphone, generating a speaker response relationship based on the microphone signal and the speaker signal, and generating an enhanced audio signal by modifying an echo associated with the microphone signal using a machine learning model and the speaker response relationship, the machine learning model being configured to differentiate between a first sound pattern and a second sound pattern.

### BACKGROUND

Wearable devices, including a head mounted display (HMD), can include a headphone(s) and a microphone(s). The microphone can include a microphone array or more than one microphone (e.g., audio sensor). The headphones can have a binaural input signal representing a three-dimensional (3D) audio to be reproduced by speakers of the headset.

### SUMMARY

Example implementations relate to suppressing echoes in order to enhance speech in devices having speakers close to microphones. In some implementations, audio signals generated by the speakers can cause echoes in audio sensed by the microphone. The echo generation can be referred to as leakage of binaural signals. Therefore, suppressing echoes can include suppressing the leakage of the binaural signals. Some implementations for suppressing the leakage of the binaural signals can include a system including a neural network to both suppress echoes and to enhance speech.

In a general aspect, a device, a system, a non-transitory computer-readable medium (having stored thereon computer executable program code which can be executed on a computer system), and/or a method can perform a process with a method including receiving a microphone signal from a microphone, receiving a speaker signal from a speaker associated with the microphone, generating a speaker response relationship based on the microphone signal and the speaker signal, and generating an enhanced audio signal by modifying an echo associated with the microphone signal using a machine learning model and the speaker response relationship, the machine learning model being trained to differentiate between a first sound pattern and a second sound pattern.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a block diagram of a two-way communications system according to an example implementation.

FIG. 2 is a block diagram illustrating a signal flow to enhance audio according to an example implementation.

FIG. 3 is a block diagram illustrating another signal flow to enhance audio according to an example implementation.

FIG. 4 is a block diagram illustrating another signal flow to enhance audio according to an example implementation.

FIG. 5 illustrates an example system for obtaining anechoic transfer relationships and/or functions according to an example implementation.

FIG. 6 illustrates a block diagram of a method of generating an audio signal according to an example implementation.

FIG. 7 illustrates a block diagram of a method of training a machine learning model to suppress echoes according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Binaural audio (which can be referred to as a binaural signal and/or a binaural audio signal) can be a two-dimensional audio (2D) audio signal. The binaural audio signal can be generated in a microphone and/or speaker configuration that is designed to generate three-dimensional (3D) audio when the binaural audio signal is played back. For example, a binaural audio signal can be recorded using two microphones that are arranged in a manner that can simulate 3D audio when the audio is reproduced using speakers. For example, a binaural audio signal can be generated based on an audio signal (e.g., a mono audio signal) and the generated binaural audio signal can be used to generate 3D audio when the audio is reproduced using speakers. The speakers can be an audio headset (e.g., as an element of a wearable device) with a left ear speaker and a right ear speaker. The left ear speaker and the right ear speaker can be configured to generate 3D audio when a person is listening the audio.

A microphone(s) can be used to sense the generated 3D audio. For example, a wearable device can include the speakers that generated the 3D audio and a microphone(s). Accordingly, the microphone(s) of the wearable device can sense (e.g., record) the 3D audio generated by the speakers of the wearable device. However, the microphone(s) sensing the 3D audio generated by the speakers can be at least one technical problem when using the wearable device, for example, in two-way communications where two or more people are communicating while wearing the wearable device. The at least one technical problem can be called leakage of binaural signals.

The leakage of the binaural signals from the headset speakers into the headset microphones can manifest as echoes during the two-way communications if the binaural signals are not adequately suppressed. Therefore, at least one technical solution to the at least one technical problem of leakage of the binaural signals can include suppressing the leakage of the binaural signals. At least one technical benefit of suppressing the leakage of the binaural signals can be a better user experience in two-way communications because echoes associated with speaker signals sensed by the microphone(s) signals can be modified, minimized, suppressed, or eliminated.

Some implementations for suppressing the leakage of the binaural signals can include a system including an adaptive filter(s) and a neural network. The adaptive filter(s) can be configured to modify and/or suppress echoes and the neural network can be configured to enhance speech and modify and/or suppress residual echoes. Some implementations for suppressing the leakage of the binaural signals can include a system including a neural network to both modify and/or suppress echoes and to enhance speech.

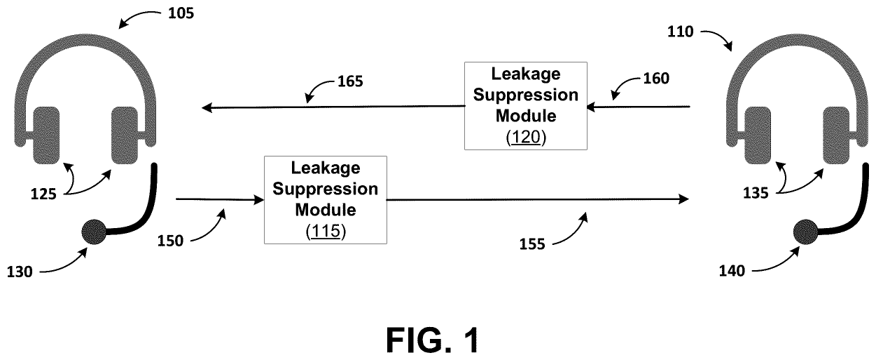

FIG. 1 illustrates a block diagram of a two-way communications system according to an example implementation. As shown in FIG. 1, the two-way communications system includes a wearable device 105, a wearable device 110, a leakage suppression module 115, and a leakage suppression module 120. The wearable device 105 includes speakers 125 and microphone 130. The wearable device 110 includes speakers 135 and microphone 140.

As shown in FIG. 1, wearable device 105 can be configured to generate an audio signal 150 (e.g., using microphone 130. The audio signal 150 can include leakage of a binaural signal. The leakage suppression module 115 can be configured to modify and/or suppress the leakage of the binaural signal of audio signal 150 and generate audio signal 155 which is communicated to the wearable device 110. The wearable device 110 can be configured to generate a binaural audio signal and the speakers 135 can be configured to generate a 3D audio signal based on the binaural audio signal.

As shown in FIG. 1, wearable device 110 can be configured to generate an audio signal 160 (e.g., using microphone 140). The audio signal 160 can include leakage of a binaural signal. The leakage suppression module 120 can be configured to modify and/or suppress the leakage of the binaural signal of audio signal 160 and generate audio signal 165 which is communicated to the wearable device 105. For example, the leakage of the binaural signal or echo can manifest as an impulse response and modifying the echo can include reducing, suppressing, filtering, and/or the like of the impulse response. The wearable device 105 can be configured to generate a binaural audio signal and the speakers 125 can be configured to generate a 3D audio signal based on the binaural audio signal. FIG. 1 illustrates the two-way communications system as including two wearable devices. However, in some implementations more than two wearable devices can be included in the two-way communications system.

The use of a residual-echo-suppression model followed by a speech-enhancement model may not significantly affect performance if the input signal is mono, apart from an increase in computation effort. However, if the input to the speech enhancement model is multi-channel as in XR headsets, the residual echo suppression may introduce non-linear effects that can distort the gain and phase of the multi-channel signals, thereby affecting the “implicit beamforming” within the neural network (NN) model. Accordingly, some implementations can be configured to perform both the residual echo suppression and speech enhancement within the same neural network model.

In some implementations, microphone signals can be received from a microphone that is proximate to a speaker. For example, the wearable device 105 and/or the wearable device 110 can include microphone 130, 140 that are proximate (e.g., a speaker(s) that is close to a microphone(s) such that the microphone(s) detects audio generated by the speaker(s)) to speakers 125, 135 by design. For example, a processor (e.g., an audio processor) can receive an audio signal(s) from a microphone(s) as a microphone signal that includes noise associated with audio generated by a speaker(s) that is proximate to the microphone(s). In some implementations, audio signals can also be received from the speaker (e.g., the speaker(s) that is proximate to the microphone(s)) as speaker signals. For example, the processor (e.g., the audio processor) can receive an audio signal(s) from a speaker(s) as a speaker signal.

In some implementations, a speaker response relationship can be generated based on the microphone signal(s) and the speaker signal(s). In some implementations, a speaker response relationship can be a mathematical functional. In some implementations, the speaker response relationship can be a loudspeaker-to-device-microphone transfer function (LDTF). A Loudspeaker-to-device-microphone can be defined as an audio signal relationship between a loudspeaker (e.g., generating the audio signal) of a device and a microphone (e.g., sensing the audio signal) of the device. The relationship can be defined in mathematical terms using signal analysis techniques. The LDTF can be generated based on the microphone signal and the speaker signal. In some implementations, the speaker response relationship (e.g., LDTF) can be generated based on the microphone signals (e.g., the microphone signal(s) without the speaker signal(s)). In some implementations, echoes associated with the microphone signal(s) can be suppressed using a machine learning model. The machine learning model can be trained (e.g., prior to use) to differentiate between audio sources associated with the speaker response relationship (e.g., LTDF).

The machine learning model can be trained based on sound diffraction patterns of the audio sources. The machine learning model can be trained based on sound diffraction patterns of the audio sources and time-of-arrival at the microphone(s). The sound diffraction patterns can be associated with the bending of audio sound waves around objects or characteristics (e.g., walls, windows, doors, and/or the like) of the room the sound is generated in. In the case of a wearable device, the sound diffraction pattern of audio sound waves generated by a speaker of the wearable device can be predictable and constant. The time-of-arrival at the microphone(s) can be based on how long it takes for an audio signal to travel from a speaker to a microphone. In the case of a wearable device, the time-of-arrival at the microphone(s) of audio signals generated by a speaker of the wearable device can be predictable and constant.

In some implementations, the echoes can be noise associated with audio generated by a speaker(s) that is proximate to the microphone(s). In some implementations, an audio signal(s) can be generated based on the microphone signal(s) with echoes suppressed (e.g., without echoes). In other words, the machine learning model can output and/or generate an audio signal(s). In some implementations, the leakage of the binaural signal or echo can manifest as an impulse response. Therefore, the machine learning model can be trained to modify the echo by reducing, suppressing, filtering, and/or the like of the impulse response.

The audio signal(s) output from the machine learning model can be an enhanced audio signal representing the microphone signal(s) with echo suppression. In some implementations, the leakage suppression module 115, 120 can include the machine learning model. Therefore, the leakage suppression module 115, 120 can be configured to generate enhanced audio signal representing the microphone signal(s) with echo suppression.

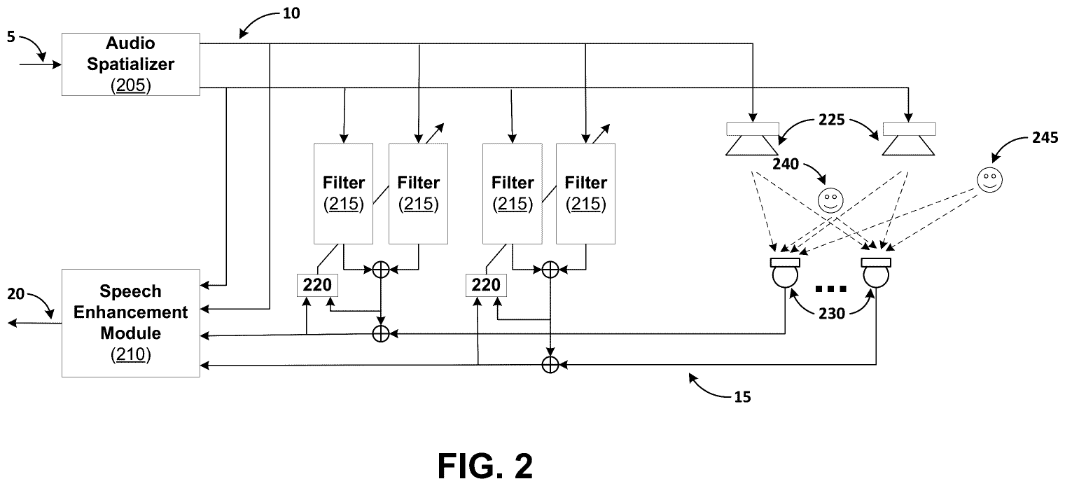

FIG. 2 is a block diagram illustrating a signal flow to enhance audio according to an example implementation. As shown in FIG. 2, the signal flow includes an audio spatializer 205, a speech enhancement module 210, filters 215 double-talk detectors 220, speakers 225, and microphones 230. In FIG. 2 an input audio signal 5 (e.g., audio signal 155, 165) is converted to a binaural audio signal 10 by the audio spatializer 205 as input to speakers 225. The audio (e.g., 3D audio) generated by the speakers 225 can be intended for user 240. In addition, the audio generated by the speakers 225 can be sensed by microphones 230. The microphones 230 can be configured to sense audio (e.g., speech) generated by user 240. In addition, noise can be generated by user 245 (e.g., as external speech and/or other undesired audio) and sensed by microphones 230. The audio generated by the speakers 225 and the noise generated by user 245 and sensed by microphones 230 may be undesirable audio sensed by the microphones 230. The audio generated by the speakers 225 and sensed by the microphones 230 can be leakage of the binaural signal of audio signal (e.g., of binaural audio signal 10). The audio signal 15 can be generated by microphones 230. The audio signal 15 (e.g., audio signal 150, 160) can include leakage of a binaural signal and noise.

FIG. 2 illustrates an example implementation of a structure configured to suppress loudspeaker echoes using adaptive filters 215 followed by a speech enhancement module 210. The speech enhancement module 210 can include a neural network model configured to enhance audio (e.g., headset user speech) and suppress residual echoes and external noise (e.g., speech). For example, the adaptive filters 215 can be configured to suppress the binaural loudspeaker echoes (e.g., a linear stereo adaptive-echo-canceller). The binaural loudspeaker echoes can be generated by (or associated with) the speakers 225. The binaural loudspeaker echoes can be leakage of the binaural audio signal 10.

Further, in some implementations the structure can include a double-talk detector(s) (DTD) 220 configured to reduce the adaptation during the presence of, for example, headset-user speech, external speech, or noise. For example, the DTD 220 can be configured to minimize or eliminate speech generated by user 245 and/or external noise (e.g., noise proximate to user 245) and sensed by microphones 230.

The speech enhancement module 210 can include a neural network. The neural network can include an input including the microphone 230 signals that have been attenuated by the adaptive filters 215, and the binaural audio signal 10 (e.g., the signals to the speakers 225). In some implementations, the binaural audio signal 10 can provide priors that make improve identification of the binaural audio signal 10 by the neural network of the speech enhancement module 210. Using the binaural audio signal 10 can improve the suppression of any remaining echoes that have not been removed by the adaptive filters 215.

In some implementations, two (2) adaptive filters 215 can be configured to cancel the leakage of the binaural audio signal 10 (e.g., echoes) from a left and right speaker 225 associated with audio signal 15. Stereo echo cancellers can suffer from a non-uniqueness problem. Therefore, some implementations can use frequency domain approaches to perform decorrelation of the reference signals to the adaptive filters, thereby improving convergence.

In some implementations, if the dominant echo for a particular microphone is from one of the speakers 225, the second adaptive filter 215 meant for canceling the other speaker 225 signal can be removed. In some implementations, if a microphone 230 is further away from the speakers 225 and has little to no leakage of the binaural audio signal 10 (e.g., echoes) associated with the audio signal 15, the adaptive filters 215 for the microphone(s) 230 can be removed.

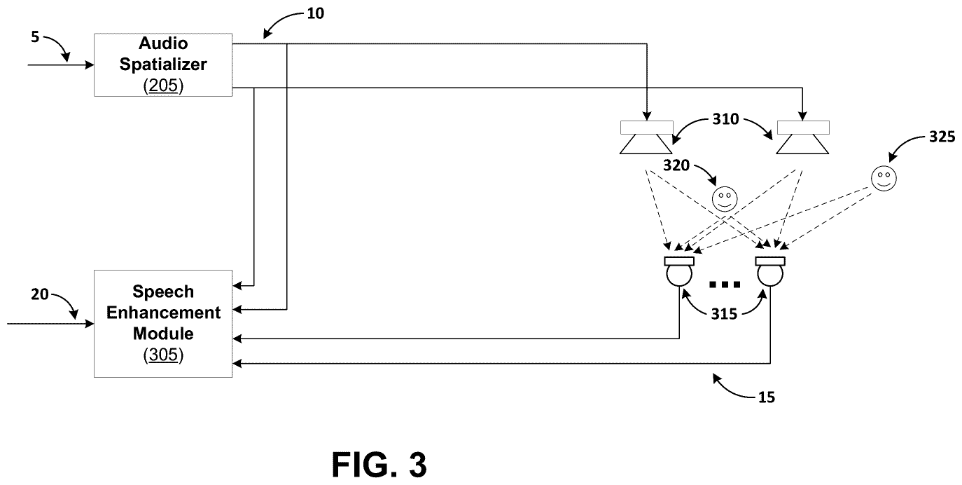

FIG. 3 is a block diagram illustrating another signal flow to enhance audio according to an example implementation. As shown in FIG. 3, the signal flow includes the audio spatializer 205, a speech enhancement module 305, speakers 310, and microphones 315. In FIG. 3 an input audio signal 5 (e.g., audio signal 155, 165) is converted to a binaural audio signal 10 by the audio spatializer 205 as input to speakers 310. The audio (e.g., 3D audio) generated by the speakers 310 can be intended for user 320. In addition, the audio generated by the speakers 310 can be sensed by microphones 315. The microphones 315 can be configured to sense audio (e.g., speech) generated by user 320. In addition, noise can be generated by user 325 (e.g., as external speech) and sensed by microphones 315. The audio generated by the speakers 310 and the noise generated by user 325 and sensed by microphones 315 may be undesirable audio sensed by the microphones 315. The audio generated by the speakers 310 and sensed by the microphones 315 can be leakage of the binaural signal of audio signal (e.g., of binaural audio signal 10). The audio signal 15 can be generated by microphones 230. The audio signal 15 (e.g., audio signal 150, 160) can include leakage of a binaural signal and noise.

In the example implementation of FIG. 3 the speech enhancement module 305 can include a neural network. In the example implementation of FIG. 3 the speech enhancement module 305 can include the binaural audio signal 10 (e.g., the input to speakers 310) and the audio signal 15 (e.g., the output of microphones 315) as inputs. Therefore, the neural network can include the binaural audio signal 10 and the audio signal 15 as inputs. The speech enhancement module 305 can be configured to enhance user 320 speech while suppressing leakage of binaural audio signal 10 (e.g., echoes) and external noise (e.g., speech associated with user 325 and/or noise in the proximity of user 325). In some implementations, the leakage of the binaural signal or echo can manifest as an impulse response. Therefore, training the neural network to modify the echo can include training the neural network to reduce, suppress, filter, and/or the like of the impulse response.

In the example implementation of FIG. 3, the adaptive filters (as in FIG. 2) are removed, and the neural network of the speech enhancement module 305 can be used to do both the leakage of the binaural audio signal 10 (e.g., echo) removal and user 320 speech enhancement. The example implementation of FIG. 3 can be feasible if audio signal 15 (e.g., microphone signals, user speech, and the like) is greater than the leakage of the binaural audio signal 10 (e.g., echoes) from the speakers 310. For example, the example implementation of FIG. 3 can be feasible in wearable devices (e.g., XR headsets). In some implementations, the binaural audio signal 10 (e.g., the input to speakers 310) can provide priors that make improve identification of the binaural audio signal 10 by the neural network of the speech enhancement module 305. Using the binaural audio signal 10 can improve the modifying, suppression and/or cancellation of leakage of the binaural audio signal 10 (e.g., echoes) by the neural network of the speech enhancement module 305.

Some implementations can include simulating the speaker response relationship for different room-reverb conditions and microphone variations when generating the neural network training data. A room can be the room in which the device is operating or being used by a user. Reverberation (or reverb) can be a reflection of an audio signal off of a surface. Reverberation can sometimes be measured as the amount of time a signal takes to dissipate (e.g., decay, or amplitude decrease) after the reflection off of the surface. Reverberation can sometimes be measured in power (e.g., dB) and time. Reverberation can be frequency dependent. In some implementations, reverberation can be associated with an echo. Therefore, reverberation can be associated with an audible frequency and the amount of time the audible frequency has a power or amplitude that remains detectable by the human ear. Accordingly, room-reverb can be associated with the reflection of an audio signal off of a surface within a room and room-reverb conditions can be associated with the types of surfaces, for example, walls, windows, furniture, fixtures, and the like that an audio signal can reflect.

Some implementations can include simulating the loudspeaker-to-device-microphones transfer functions (LDTFs) for different room-reverb conditions and microphone variations when generating the neural network training data. In the example implementation of FIG. 3, adaptive filters to adapt to the channel and attenuate the echoes are not included. Therefore, simulating the different room-reverb conditions and microphone variations enables the neural network to rely more on prior knowledge of sound diffraction and microphones/channels variations to beamform (e.g., implicitly beamform) and suppress the echoes and external noise (e.g., speech). Implicit beamforming can form a beam without any information on the device that the beam is directed to. Whereas explicit beamforming can form the beam with information on the device that the beam is directed to. In some implementations, there is no information on the receiving device. Therefore, beamforming can be implicit beamforming. However, the implicit beamforming can be improved based on prior knowledge of sound diffraction and microphones/channels variations.

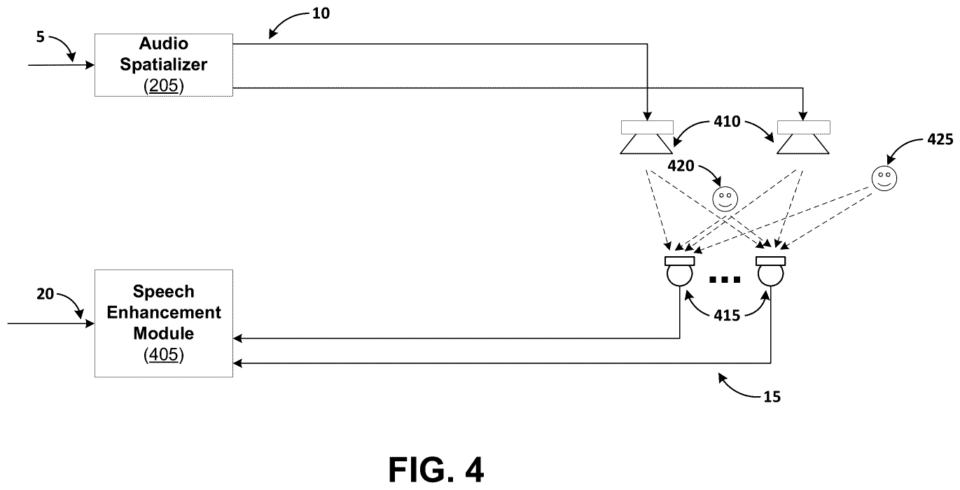

FIG. 4 is a block diagram illustrating another signal flow to enhance audio according to an example implementation. As shown in FIG. 4, the signal flow includes the audio spatializer 205, a speech enhancement module 405, speakers 410, and microphones 415. In FIG. 4 an input audio signal 5 (e.g., audio signal 155, 165) is converted to a binaural audio signal 10 by the audio spatializer 205 as input to speakers 410. The audio (e.g., 3D audio) generated by the speakers 410 can be intended for user 420. In addition, the audio generated by the speakers 410 can be sensed by microphones 415. Microphones 415 can be configured to sense audio (e.g., speech) generated by user 420. In addition, noise can be generated by user 425 (e.g., as external speech) and/or other noise can be generated and sensed by microphones 415. The audio generated by the speakers 410 and the noise generated by user 425 and sensed by microphones 415 may be undesirable audio sensed by the microphones 415. The audio generated by the speakers 410 and sensed by the microphones 415 can be leakage of the binaural signal of audio signal (e.g., of binaural audio signal 10). The audio signal 15 can be generated by microphones 415. The audio signal 15 (e.g., audio signal 150, 160) can include leakage of a binaural signal and noise.

The example implementation of FIG. 4 is similar to the example implementation illustrated in FIG. 3 except that binaural audio signal 10 (e.g., the input signal to the speaker 410) are not inputs to the speech enhancement module 405. neural network model.

In the example implementation of FIG. 4 the speech enhancement module 405 can include a neural network. In the example implementation of FIG. 4 the speech enhancement module 405 can include the audio signal 15 (e.g., the output of microphones 315) as inputs. Therefore, the neural network can include the audio signal 15 as inputs. The speech enhancement module 405 can be configured to enhance user 420 speech while suppressing leakage of the binaural audio signal 10 (e.g., echoes) and external noise (e.g., speech associated with user 425 and/or noise in the proximity of user 425).

Therefore, the neural network can be configured to enhance user 420 speech while suppressing leakage of the binaural audio signal 10 (e.g., echoes) and external noise (e.g., speech associated with user 425 and/or noise in the proximity of user 425).In this example implementation, the neural network can be trained to differentiate between the desired and undesired audio based on audio diffraction patterns (or sound diffraction patterns) and time-of-arrival at the microphones. In some implementations, the leakage of the binaural signal or echo can manifest as an impulse response. Therefore, training the neural network to modify the echo can include training the neural network to reduce, suppress, filter, and/or the like of the impulse response.

If the placement and number of microphones are optimal with respect to providing the differentiating features between the desired and undesired audio, the example implementation of FIG. 4 can have similar performance as the example implementation illustrated in FIG. 3. Therefore, in the example of FIG. 4 the number of microphones 415 and the placement of the microphones 415 may be important when in use and when training. In some implementations, the training of the neural network of the speech enhancement module 405 may include the modeling of a speaker response relationship (e.g., LDTF) and microphone variations.

In some implementations, the speakers 225, 310, 410 and microphones 230, 315, 415 can be included in a wearable device (e.g., a head mounted display (HMD), an AR/VR/XR headset, smart glasses, and/or the like). In some implementations, the form-factor of the XR headset speakers can be small. Therefore, the audio output can be susceptible to non-linear distortions at high volume. These distortions can manifest as harmonics that make it difficult for the linear adaptive echo-canceller to remove. To enable the neural-network model (e.g., of the speech enhancement model 210, 305, 405) to effectively remove the harmonics distortions, the harmonics distortions can be measured at various audio levels (e.g., amplitude, power, volume, and/or the like), and then the measured distortions can be incorporated during training of the neural network. In some implementations, the leakage of the binaural signal or echo can manifest as an impulse response. Therefore, training the neural network to modify the echo can include training the neural network to reduce, suppress, filter, and/or the like of the impulse response.

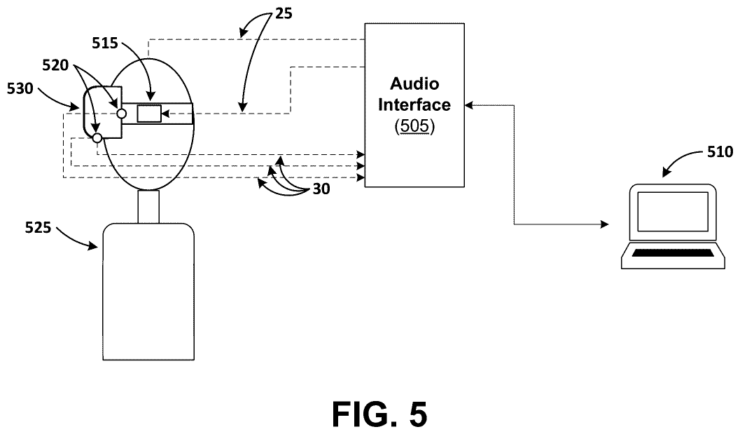

FIG. 5 illustrates an example system for obtaining anechoic transfer relationships and/or functions according to an example implementation. As shown in FIG. 5, the system includes an audio interface 505, a computing device 510, a speaker(s) 515, and a microphone(s) 520. The speaker(s) 515, and microphone(s) 520 can be elements of a wearable device 530 worn by a test subject 525. In some implementations, the computing device 510 can generate an audio signal and communicate the audio signal to the audio interface 505. In some implementations, the audio signal generated by the computing device 510 can be a binaural audio signal. In some implementations, the audio interface 505 can be configured to generate a binaural audio signal based on the audio signal generated by the computing device 510.

The audio interface 505 can communicate a left speaker audio signal and a right speaker audio signal to the speaker(s) 515 and the speaker(s) 515 can generate audio based on the left speaker audio signal and a right speaker audio signal. In some implementations, the left speaker audio signal and a right speaker audio signal can be binaural audio signals and the speaker(s) 515 can be configured to generate 3D audio based on the binaural audio signal.

In some implementations, an anechoic transfer relationship(s) and/or function(s) can be used to generate a speaker response relationship. An anechoic transfer function can be a linear, time-invariant function of a sound wave in an anechoic environment. In some implementations, an anechoic transfer relationship(s) and/or function(s) can be used to generate loudspeaker-to-device-microphones transfer functions (LDTF). For example, the system illustrated in FIG. 5 can be used to obtain the anechoic transfer relationship(s) and/or function(s) and then room variations can be synthetically incorporated to generate the speaker response relationships (e.g., LDTFs). In some implementations, the speaker response relationships (e.g., LDTFs) can be used for training the neural network. In some implementations, in order to improve the diversity of the different head sizes and shapes, the anechoic transfer relationship(s) and/or function(s) (and therefore the speaker response relationship (e.g., LDTFs)) can be obtained by placing the wearable device 530 on test subject 525 (e.g., human test subjects). However, for evaluation purposes, the anechoic transfer relationship(s) and/or function(s) (and therefore the speaker response relationship (e.g., LDTFs)) should represent real-world environments. Therefore, the anechoic transfer relationship(s) and/or function(s) (and therefore the speaker response relationships (e.g., LDTFs)) can be collected in various rooms and room types using the wearable device 530 and test subject 525.

In some implementations, the training of the machine learning model can include generating training data based on a plurality of speaker response relationships (e.g., LDTFs) for different room-reverb conditions and microphone variations. For example, the test subject 525 can be placed in many test chambers having different physical characteristics. The physical characteristics can include, for example, chamber dimensions, chamber material, objects included in the chamber, number of walls, position of the test subject 525 within the chamber, and the like. In addition, the speaker(s) 515 and/or the microphone(s) 520 can be positioned differently with respect to the test chamber, the test subject 525, and/or each other.

In some implementations, the plurality of speaker response relationships (e.g., LDTFs) can be reverberant speaker response relationships (e.g., reverberant LDTFs) generated based on anechoic speaker response relationships (e.g., anechoic LDTFs). A reverberant speaker response can be the response of a speaker in a free field. A free field can be an environment free of reflecting surfaces. Therefore, a free field can be an environment in which sound can radiate freely in all directions. Anechoic is defined as lacking echoes. Therefore, an anechoic speaker response can be the response of a speaker without echoes. The anechoic speaker response can be generated in a room (e.g., an anechoic chamber) having surfaces that do not reflect audio signals. For example, the test chamber can be an anechoic chamber and the LTDFs can be generated with data collected using the anechoic chamber. An anechoic chamber can be designed to prevent echoes and/or signal reflections off of the surface of the walls of the chamber.

In some implementations, reverberant speaker response relationships (e.g., reverberant LDTFs) can be generated by combining reverberation signals representing a room reverberation with the anechoic speaker response relationships (e.g., anechoic LDTFs). For example, microphones can be used to detect and/or generate audio signals as reverberation signals. The audio signals can be collected in test chambers that are configured to reflect signals off of, for example, walls, objects, and the like. The reverberations signals can be combined with the anechoic speaker response relationships (e.g., anechoic LDTFs) using signal processing techniques.

In some implementations, training the machine learning model can include generating echoes (e.g., noise, simulated speaker audio, and the like) by convolving training speaker signals with the reverberant speaker response relationships (e.g., reverberant LDTFs). In some implementations, the echoes can be impulse responses. In some implementations, the machine learning model can be trained to implicitly beamform and suppress echoes associated with speaker signals and suppress external noise. Beamforming audio can include adapting audio based on frequency, volume, direction, and the like. Adapting can include changing (e.g., reducing) a volume associated with an audio signal having specific directional and/or frequency characteristics.

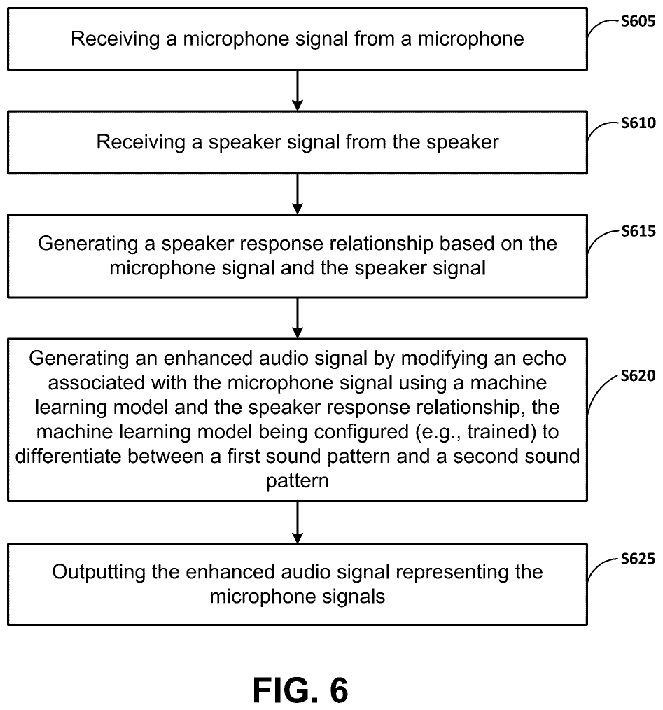

Example 1. FIG. 6 is a block diagram of a method of operating an audio generating system according to an example implementation. As shown in FIG. 6, in step S605 receiving a microphone signal from a microphone. In step S610 receiving a speaker signal from a speaker associated with the microphone. In some implementations, the speaker associated can be proximate (e.g., close to) the microphone. For example, in a headset or head mounted display a speaker can be within inches of each other (e.g., the distance from an ear to a mouth0. In step S615 generating a speaker response relationship based on the microphone signal and the speaker signal. In some implementations, the speaker response relationship can be a functional relationship. In some implementations, the speaker response relationship can be a mathematical functional. In some implementations, the speaker response relationship can be a loudspeaker-to-device-microphone transfer function (LDTF) that can be generated based on the microphone signal and the speaker signal. In step S620 generating an enhanced audio signal by modifying an echo associated with the microphone signal using a machine learning model and the speaker response relationship, the machine learning model being configured (e.g., trained) to differentiate between a first sound pattern and a second sound pattern. In some implementations, modifying an echo associated with the microphone signal can include suppressing the echo associated with the microphone signal. In some implementations, the echo can be suppressed using the LDTF. In some implementations, the machine learning model can be trained to differentiate between a plurality of audio sources. In some implementations, the machine learning model can be trained to differentiate between sound diffraction patterns of the audio sources. In some implementations, the machine learning model can be trained to differentiate between sound diffraction patterns of the audio sources and time-of-arrival at the microphone. In step S625 outputting the enhanced audio signal representing the microphone signals.

Example 2. The method of Example 1, wherein training the machine learning model can include generating training data based on a plurality of speaker response relationships (e.g., (LDTFs) for different room-reverb conditions and microphone variations.

Example 3. The method of Example 2, wherein the plurality of speaker response relationships can be reverberant speaker response relationships (e.g., reverberant LDTFs) generated based on anechoic speaker response relationships (e.g., anechoic LDTFs).

Example 4. The method of Example 3, wherein the anechoic speaker response relationships can be collected in an anechoic chamber.

Example 5. The method of Example 3, wherein the reverberant speaker response relationships can be generated by combining reverberation signals representing a room reverberation with the anechoic speaker response relationships.

Example 6. The method of Example 3, wherein training the machine learning model can include generating echoes by convolving training speaker signals with the reverberant speaker response relationships.

Example 7. The method of Example 6, wherein the echo can be an impulse response. Therefore, training the neural network to modify the echo can include training the neural network to reduce, suppress, filter, and/or the like of the impulse response.

Example 8. The method of Example 1, wherein the machine learning model can be trained to implicitly beamform and suppress echoes associated with speaker signals and suppress external noise.

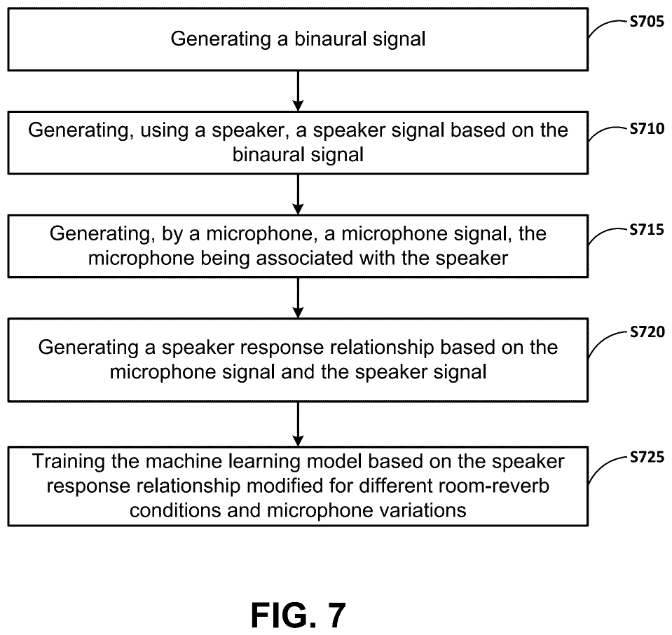

Example 9. FIG. 7 is a block diagram of a method of training a machine learning model to suppress echoes according to an example implementation. As shown in FIG. 7, in step S705 generating a binaural signal. In step S710 generating, using a speaker, a speaker signal based on the binaural signal. In step S715 generating, by a microphone, a microphone signal, the microphone being associated with the speaker (e.g., a predetermined distance from and/or close to the speaker. In step S720 generating a speaker response relationship (e.g., LDTF) based on the microphone signal and the speaker signal. In step S725 training the machine learning model based on the speaker response relationship (e.g., LDTF) modified for different room-reverb conditions and microphone variations.

Example 10. The method of Example 9, wherein modifying the speaker response relationship (e.g., LDTF) can include generating a reverberant speaker response relationship (e.g., reverberant LDTF) based on an anechoic LDTF.

Example 11. The method of Example 10, wherein the speaker signal and the microphone signal can be generated in an anechoic chamber and the anechoic speaker response relationship (e.g., anechoic LDTF) can be generated based on the speaker signal and the microphone signal generated in the anechoic chamber.

Example 12. The method of Example 10, wherein the reverberant speaker response relationship (e.g., reverberant LDTF) can be generated by combining reverberation signals representing a room reverberation with the anechoic speaker response relationship (e.g., anechoic LDTF).

Example 13. The method of Example 10, wherein the training of the machine learning model can include generating echoes by convolving the speaker signals with the reverberant speaker response relationships (e.g., reverberant LDTFs).

Example 14. The method of Example 13, wherein the echoes can be impulse responses.

Example 15. The method of Example 9, wherein the speaker and the microphone can be included in a wearable device, for example, a head mounted display (HMD), an AR/VR/XR headset, smart glasses, and/or the like.

Example 16. A method can include any combination of one or more of Example 1 to Example 15.

Example 17. A non-transitory computer-readable storage medium comprising instructions stored thereon that, when executed by at least one processor, are configured to cause a computing system to perform the method of any of Examples 1-16.

Example 18. An apparatus comprising means for performing the method of any of Examples 1-16.

Example 19. An apparatus comprising at least one processor and at least one memory including computer program code, the at least one memory and the computer program code configured to, with the at least one processor, cause the apparatus at least to perform the method of any of Examples 1-16.

Example 20. A wearable device configured to perform the method of any of Examples 1-16.

Example 21. A head mounted display (HMD) configured to perform the method of any of Examples 1-16.

Example 22. An AR/VR/XR/MR headset, smart glasses, and/or the like configured to perform the method of any of Examples 1-16.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A non-transitory computer-readable storage medium comprising instructions stored thereon that, when executed by a processor, are configured to cause the processor to:
receive a microphone signal from a microphone;
receive a speaker signal from a speaker associated with the microphone;
generate a speaker response relationship based on the microphone signal and the speaker signal; and
generate an enhanced audio signal by modifying an echo associated with the microphone signal using a model and the speaker response relationship, the model being configured to differentiate between a first sound pattern and a second sound pattern.

2. The non-transitory computer-readable storage medium of claim 1, wherein the instructions are further configured to cause the processor to output the enhanced audio signal representing the microphone signal.

3. The non-transitory computer-readable storage medium of claim 1, wherein the speaker response relationship is a loudspeaker-to-device-microphone transfer function.

4. The non-transitory computer-readable storage medium of claim 1, wherein
the model is a machine learning model, and
training the machine learning model includes generating training data based on a plurality of speaker response relationships for different room-reverb conditions and microphone variations.

5. The non-transitory computer-readable storage medium of claim 4, wherein the plurality of speaker response relationships are reverberant speaker response relationships generated based on anechoic speaker response relationships.

6. The non-transitory computer-readable storage medium of claim 5, wherein the anechoic speaker response relationships are collected in an anechoic chamber.

7. The non-transitory computer-readable storage medium of claim 5, wherein the reverberant speaker response relationships are generated by combining reverberation signals representing a room reverberation with the anechoic speaker response relationships.

8. The non-transitory computer-readable storage medium of claim 5, wherein
the model is a machine learning model, and
training the machine learning model includes generating echoes by convolving training speaker signals with the reverberant speaker response relationships.

9. The non-transitory computer-readable storage medium of claim 8, wherein the echo is an impulse response.

10. The non-transitory computer-readable storage medium of claim 1, wherein
the model is a machine learning model, and
the machine learning model is trained to beamform and suppress echoes associated with speaker signals and suppress external noise.

11. The non-transitory computer-readable storage medium of claim 1, wherein the model is a machine learning model, the instructions are further configured to cause the processor to:
generate a binaural signal;
generate, using a speaker, a speaker signal based on the binaural signal;
generate, by a microphone, a microphone signal, the microphone being associated with the speaker;
generate a speaker response relationship based on the microphone signal and the speaker signal; and
configuring the machine learning model based on the speaker response relationship modified for different room-reverb conditions and microphone variations.

12. The non-transitory computer-readable storage medium of claim 11, wherein the speaker response relationship is a loudspeaker-to-device-microphone transfer function.

13. The non-transitory computer-readable storage medium of claim 11, wherein modifying the speaker response relationship includes generating a reverberant speaker response relationship based on an anechoic speaker response relationship.

14. The non-transitory computer-readable storage medium of claim 13, wherein
the speaker signal and the microphone signal are generated in an anechoic chamber; and
the anechoic speaker response relationship is generated based on the speaker signal and the microphone signal generated in the anechoic chamber.

15. The non-transitory computer-readable storage medium of claim 13, wherein the reverberant speaker response relationship is generated by combining reverberation signals representing a room reverberation with the anechoic speaker response relationship.

16. The non-transitory computer-readable storage medium of claim 13, wherein the training of the machine learning model includes generating an echo by convolving the speaker signal with the reverberant speaker response relationship.

17. The non-transitory computer-readable storage medium of claim 16, wherein the echo is an impulse response.

18. The non-transitory computer-readable storage medium of claim 11, wherein the speaker and the microphone are included in a wearable device.

19. A wearable device including a processor configured to:
receive a microphone signal from a microphone;
receive a speaker signal from a speaker associated with the microphone;
generate a speaker response relationship based on the microphone signal and the speaker signal; and
generate an enhanced audio signal by modifying an echo associated with the microphone signal using a model and the speaker response relationship, the model being trained to differentiate between a first sound pattern and a second sound pattern.

20. The wearable device of claim 19, wherein the speaker response relationship is a loudspeaker-to-device-microphone transfer function.

21. The wearable device of claim 19, wherein
the model is a machine learning model, and
training the machine learning model includes generating training data based on a plurality of speaker response relationships for different room-reverb conditions and microphone variations.

22. The wearable device of claim 21, wherein the plurality of speaker response relationships are reverberant speaker response relationships generated based on anechoic speaker response relationships.

23. The wearable device of claim 22, wherein
the anechoic speaker response relationships are collected in an anechoic chamber, and
the reverberant speaker response relationships are generated by combining reverberation signals representing a room reverberation with the anechoic speaker response relationships.

24. The wearable device of claim 22, wherein
the model is a machine learning model, and
training the machine learning model includes generating echoes by convolving training speaker signals with the reverberant speaker response relationships.

25. A method comprising:
receiving a microphone signal from a microphone;
receiving a speaker signal from a speaker associated with the microphone;
generating a speaker response relationship based on the microphone signal and the speaker signal; and
generating an enhanced audio signal by modifying an echo associated with the microphone signal using a model and the speaker response relationship, the model being configured to differentiate between a first sound pattern and a second sound pattern.
